(19) United States
(12) Patent Application Publication
(10) Pub. No.: US 2003/0122783 A1
(43) Pub. Date: Jul. 3, 2003

(54) Horizontal wheel user input device

(76) Inventor: Carl I. Green, Portland, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/041,039

(22) Filed: Dec. 28, 2001

(51) Int. Cl. G09G 5/00

(52) U.S. Cl. 345/168

(57) ABSTRACT

A user input apparatus including wheel positioned horizontally relative to keyboard surface of a portable computer, wherein rotation of the wheel communicates user input to the computer.

### BACKGROUND

There exists a continuous need in the portable computer field to improve the ergonomics and the efficiency of providing user input devices. For example, in some computers today, a touch pad is placed below the space bar of the keyboard of the portable notebooks. One deficiency of the touch pad is that it may be sensitive to human heat as the users hands or fingers pass over the touch pad. As a result, the touch pad at times may process unintended user input, resulting in unwanted movement of documents and objects and/or possible unwanted edits of the same.

Therefore what is needed is a user input device that more accurately process intended user input. Furthermore, the user input device should be ergonomically located on the keyboard of the portable computer so as to be relatively easily found and operated by a user.

### BRIEF DESCRIPTION OF THE DRAWINGS

FIG. 1 is a illustration of the horizontal wheel user input device according to one embodiment.

FIG. 2 is a illustration of the horizontal wheel user input device according to an alternative embodiment.

### DETAILED DESCRIPTION

The present application describes a horizontal wheel user input device. In the following description, for purposes of explanation, numerous specific details are set forth in order to provide a thorough understanding of the invention.

It will be apparent however, to one skilled in the art that the invention can be practiced without these specific details. In other instances, structures and devices are shown in block diagram form in order to avoid obscuring the invention. Reference in the specification to “one embodiment” or “an embodiment” means that a particular feature, structure, or characteristic described in connection with the embodiment is included in at least one embodiment of the invention. The appearances of the phrase “in an embodiment” in various places in the specification are not necessarily all referring to the same embodiment.

In one embodiment, the user input device includes rotational device displaced horizontal to the top surface of a keyboard. The user input device rotates horizontally relative to the top surface of the keyboard. The user input device described herein is interchangeably identified as the horizontal wheel, user input device, and the horizontal wheel user input device.

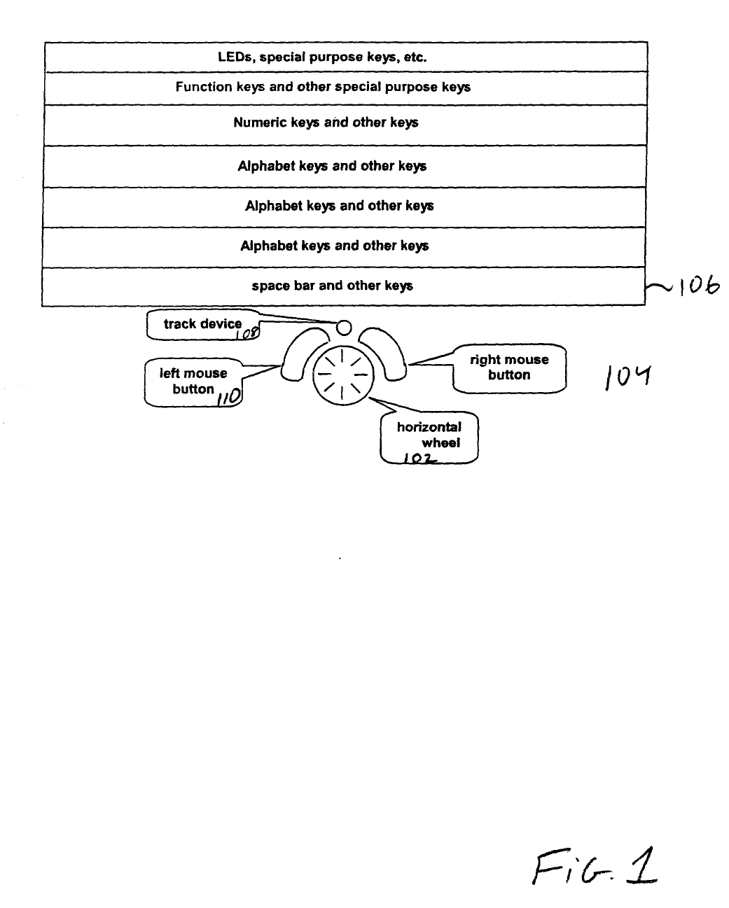

FIG. 1 illustrates one embodiment of the user input device 102. As shown in FIG. 1, the user input device 102 is provided on the keyboard 104 below the space bar 106. By placing the user input device below the space bar, the user input device is ergonomically positioned to be operated with a user's thumbs, while substantially maintaining the user's fingers over the keyboard.

As a result an operator of the keyboard may operate the keyboard and operate the user input with less movement of their hand(s). In alternative embodiments, the users input device may be positioned in alternative locations without departing from the invention.

In one embodiment, rotation of the user input device 102 moves an object (e.g., documents) displayed on a display of the computer. For example, in one embodiment, clockwise rotation of the user input device 102 will result in scrolling down a displayed document. Counter clockwise rotation of the user input device will result in scrolling up a displayed document.

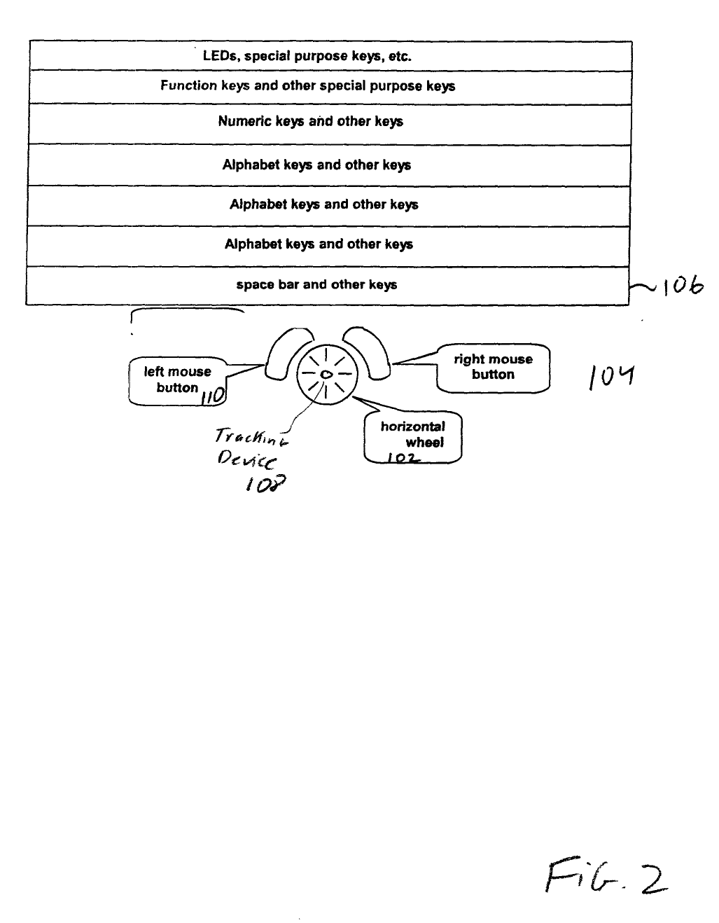

More specifically, an operator may use the tracking device 108, as shown in FIG. 1, to place a displayed cursor over a displayed object. Once the tracking device has been used to locate the cursor over a selected item, the operator may activate the left mouse button 110 to select a displayed object. The operator may then use the horizontal wheel to move the selected object. FIG. 2 illustrates an alternative embodiment wherein the tracking device 108 is provided in the center of the horizontal wheel 102.

In alternative embodiments, the horizontal wheel user input device may be used for alternative input activities. For example, in one embodiment, the horizontal wheel may be used to provide variable input to an application being executed. In one instance, the variable input includes numerical input, wherein rotation of the wheel in a first direction increases a numerical value, and rotation of the wheel in a second direction decreases the numerical value.

In one embodiment, rotation of the horizontal wheel will be received by a keyboard buffer and passed on to a keyboard controller. The keyboard controller will generate an interrupt and communicate the user input from the horizontal wheel to the video adapter to effectuate the desired user input.

In one embodiment, the surface of the user input device includes ridges to assist in providing friction between the surface of the operator's thumbs or fingers and the surface of the user input device. In alternative embodiments, alternatives to the ridges may be used to provide traction between the surface of the operator's thumbs or fingers and the surface of the user input device.

Although the present invention has been described with reference to specific exemplary embodiments, it will be evident that various modifications and changes may be made to these embodiments without departing from the broader spirit and scope of the invention. For example, the user input/horizontal wheel as described above could be integrated onto a keyboard that is not connected to a computer. The user input/horizontal wheel could be used with a computer that is not considered portable. Moreover, the user input/horizontal wheel as described above could be implemented separate from a keyboard. Accordingly, the specification and drawings are to be regarded in an illustrative rather than a restrictive sense.

What is claimed is:

1. A user input apparatus comprising:
a wheel positioned horizontally relative to keyboard surface of a portable computer, wherein rotation of the wheel communicates user input to the computer.

2. The apparatus of claim 1, wherein the wheel is positioned below a space bar of the keyboard surface, substantially in a center of the keyboard surface.

3. The apparatus of claim 3, wherein the wheel includes a tracking device to provide user input to direct a cursor displayed on a display of a portable computer.

4. The apparatus of claim 3, wherein the tracking device is placed substantially in a center of the wheel.

5. The apparatus of claim 2, wherein the wheel includes ridges to provide friction.

6. The apparatus of claim 2, wherein rotation of the wheel moves an object displayed on a display of the portable computer, in a vertical direction.

7. The apparatus of claim 2, wherein rotation of the wheel provides variable input to an application being executed on the portable computer.

8. The apparatus of claim 7, wherein the variable input includes numerical input, wherein rotation of the wheel in a first direction increases a numerical value, and rotation of the wheel in a second direction decreases the numerical value.

9. A portable computer comprising:
A user input device comprising a wheel positioned horizontally relative to keyboard surface of a portable computer, wherein rotation of the wheel communicates user input to the computer.

10. The portable computer of claim 9, wherein the wheel is positioned below a space bar of the keyboard surface, substantially in a center of the keyboard surface.

11. The portable computer of claim 10, wherein the wheel includes a tracking device to provide user input to direct a cursor displayed on a display of a portable computer, the tracking device is placed substantially in a center of the wheel.

12. The portable computer of claim 11, wherein rotation of the wheel provides variable input to an application being executed on the portable computer.

13. The portable computer of claim 12, wherein the variable input includes numerical input, wherein rotation of the wheel in a first direction increases a numerical value, and rotation of the wheel in a second direction decreases the numerical value.

14. A computer comprising:
A user input device comprising a wheel positioned horizontally relative to keyboard surface of a portable computer, the wheel is further positioned below a space bar of the keyboard surface, substantially in a center of the keyboard surface, and rotation of the wheel communicates user input to the computer; and
Tracking device to provide user input to direct a cursor displayed on a display of the computer, the tracking device is placed substantially in a center of the wheel.

15. The computer of claim 14, wherein rotation of the wheel moves an object displayed on a display of the computer, in a vertical direction.

16. The computer of claim 14, wherein rotation of the wheel provides variable input to an application being executed on the computer.
